(19) United States
(12) Patent Application Publication
(10) Pub. No.: US 2025/0001951 A1
(43) Pub. Date: Jan. 2, 2025

(54) VEHICLE WITH MULTI-USE HOOP

(71) Applicant: TEXTRON INC, PROVIDENCE, RI (US)

(72) Inventors: Michael O’Brien Dalton, Evans, GA (US); Scott Wohlgamuth, Martinez, GA (US); Matthew Daniel Wilson, Graniteville, SC (US); Rebecca Ann Hassan, Augusta, GA (US); Michael Johnathan Laine, Graniteville, SC (US)

(21) Appl. No.: 18/345,345

(22) Filed: Jun. 30, 2023

(51) Int. Cl. B60R 9/08

(52) U.S. Cl. CPC B60R 9/08

(57) ABSTRACT

A vehicle, wherein the vehicle comprises a chassis, a plurality of wheels operatively connected to the chassis, a passenger compartment supported by the chassis, and at least one multi-use accessory retention loop disposed on the vehicle and structured and operable to retain a passenger personal item.

### FIELD

The present teachings relate to vehicles, e.g., golf cars, and more particularly to a vehicle, e.g., a golf car, having one or more multi-use accessory retention loop for retaining user personal accessories.

### BACKGROUND

The statements in this section merely provide background information related to the present disclosure and may not constitute prior art.

During a round of golf, golf gloves, towels and other golfer personal accessories can become wet from sweat. Traditionally, golfers hang such personal accessories from the steering wheel or a strut or other locations of the golf car to allow them to dry between uses. The steering wheel and strut and other locations of a golf car are not designed for hanging such personal accessories therefrom, nor for retaining such personal accessories during operation of the golf car. As a consequence, hanging personal accessories from such non-intended or non-purposed locations on the golf car can interfere with operation of the vehicle, be cumbersome and inconvenient deposition and retrieval of the personal accessory, and/or allow the personal accessory to fall off and/or blow off during operation of the golf car.

### SUMMARY

In various embodiments the present disclosure provides a vehicle, wherein the vehicle comprises a chassis, a plurality of wheels operatively connected to the chassis, and a passenger compartment supported by the chassis, and at least one multi-use accessory retention loop disposed on the vehicle and structured and operable to retain a passenger personal item.

In various other embodiments, the present disclosure provides a vehicle sweater basket and golf bag retention structure mounted to at least one rear strut of a canopy system of the vehicle and structured and operable to stow passenger personal items, wherein said sweater basket and golf bag retention structure comprises at least one multi-use accessory retention loop structured and operable to retain a passenger personal item.

This summary is provided merely for purposes of summarizing various example embodiments of the present disclosure so as to provide a basic understanding of various aspects of the teachings herein. Various embodiments, aspects, and advantages will become apparent from the following detailed description taken in conjunction with the accompanying drawings which illustrate, by way of example, the principles of the described embodiments. Accordingly, it should be understood that the description and specific examples set forth herein are intended for purposes of illustration only and are not intended to limit the scope of the present teachings.

### DRAWINGS

The drawings described herein are for illustration purposes only and are not intended to limit the scope of the present teachings in any way.

FIG. 1 is an exemplary side view of a vehicle comprising one or more multi-use accessory retention loop, in accordance with various embodiments of the present disclosure.

FIG. 2 is an exemplary side view of a multi-use accessory retention loop shown in FIG. 1, in accordance with various embodiments of the present disclosure.

FIGS. 3A and 3B exemplarily illustrates the multi-use accessory retention loop shown in FIG. 2 being disposed on, mounted to, or integrally formed with a sweater basket and golf bag retention structure of the vehicle shown in FIG. 1, in accordance with various embodiments of the present disclosure.

FIG. 4 exemplarily illustrates the multi-use accessory retention loop shown in FIG. 2 being disposed on, mounted to, or integrally formed with dash console/instrument panel of the vehicle shown in FIG. 1, in accordance with various embodiments of the present disclosure.

FIG. 5 is a cross-section view of a canopy of the vehicle shown in FIG. 1 exemplarily illustrating the multi-use accessory retention loop shown in FIG. 2 being disposed on, mounted to, or integrally formed with the canopy of the vehicle shown in FIG. 1, in accordance with various embodiments of the present disclosure.

FIG. 6 is exemplarily illustrates the multi-use accessory retention loop shown in FIG. 2 being disposed on, mounted to, or integrally formed with a sand bottle retention cup of vehicle shown in FIG. 1, in accordance with various embodiments of the present disclosure.

FIG. 7 is exemplarily illustrates the multi-use accessory retention loop shown in FIG. 2 being disposed on, mounted to, or integrally formed with a seating structure hip restraint of vehicle shown in FIG. 1, in accordance with various embodiments of the present disclosure.

FIG. 8 is exemplarily illustrates the multi-use accessory retention loop shown in FIG. 2 being disposed on, mounted to, or integrally formed with a seating structure seat back of vehicle shown in FIG. 1, in accordance with various embodiments of the present disclosure.

Corresponding reference numerals indicate corresponding parts throughout the several views of drawings.

### DETAILED DESCRIPTION

The following description is merely exemplary in nature and is in no way intended to limit the present teachings, application, or uses. Throughout this specification, like reference numerals will be used to refer to like elements. Additionally, the embodiments disclosed below are not intended to be exhaustive or to limit the invention to the precise forms disclosed in the following detailed description. Rather, the embodiments are chosen and described so that others skilled in the art can utilize their teachings. As well, it should be understood that the drawings are intended to illustrate and plainly disclose presently envisioned embodiments to one of skill in the art, but are not intended to be manufacturing level drawings or renditions of final products and may include simplified conceptual views to facilitate understanding or explanation. As well, the relative size and arrangement of the components may differ from that shown and still operate within the spirit of the invention.

As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims.

Unless otherwise defined, all technical and scientific terms used herein have the same meaning as commonly understood by one of ordinary skill in the art to which this disclosure belongs. The terminology used herein is for the purpose of describing particular example embodiments only and is not intended to be limiting. As used herein, the singular forms “a”, “an”, and “the” may be intended to include the plural forms as well, unless the context clearly indicates otherwise. The terms “comprises”, “comprising”, “including”, and “having” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps can be employed.

When an element, object, device, apparatus, component, region or section, etc., is referred to as being “on”, “engaged to or with”, “connected to or with”, or “coupled to or with” another element, object, device, apparatus, component, region or section, etc., it can be directly on, engaged, connected or coupled to or with the other element, object, device, apparatus, component, region or section, etc., or intervening elements, objects, devices, apparatuses, components, regions or sections, etc., can be present. In contrast, when an element, object, device, apparatus, component, region or section, etc., is referred to as being “directly on”, “directly engaged to”, “directly connected to”, or “directly coupled to” another element, object, device, apparatus, component, region or section, etc., there may be no intervening elements, objects, devices, apparatuses, components, regions or sections, etc., present. Other words used to describe the relationship between elements, objects, devices, apparatuses, components, regions or sections, etc., should be interpreted in a like fashion (e.g., “between” versus “directly between”, “adjacent” versus “directly adjacent”, etc.).

As used herein the phrase “operably connected to” will be understood to mean two are more elements, objects, devices, apparatuses, components, etc., that are directly or indirectly connected to each other in an operational and/or cooperative manner such that operation or function of at least one of the elements, objects, devices, apparatuses, components, etc., imparts or causes operation or function of at least one other of the elements, objects, devices, apparatuses, components, etc. Such imparting or causing of operation or function can be unilateral or bilateral.

As used herein, the term “and/or” includes any and all combinations of one or more of the associated listed items. For example, A and/or B includes A alone, or B alone, or both A and B.

Although the terms first, second, third, etc. can be used herein to describe various elements, objects, devices, apparatuses, components, regions or sections, etc., these elements, objects, devices, apparatuses, components, regions or sections, etc., should not be limited by these terms. These terms may be used only to distinguish one element, object, device, apparatus, component, region or section, etc., from another element, object, device, apparatus, component, region or section, etc., and do not necessarily imply a sequence or order unless clearly indicated by the context.

Moreover, it will be understood that various directions such as “upper”, “lower”, “bottom”, “top”, “left”, “right”, “first”, “second” and so forth are made only with respect to explanation in conjunction with the drawings, and that components may be oriented differently, for instance, during transportation and manufacturing as well as operation. Because many varying and different embodiments may be made within the scope of the concept(s) taught herein, and because many modifications may be made in the embodiments described herein, it is to be understood that the details herein are to be interpreted as illustrative and non-limiting.

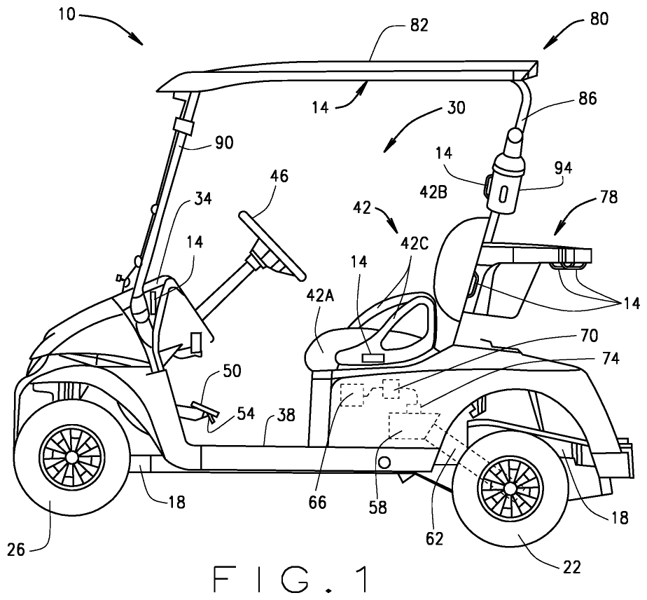

Referring now to FIG. 1, the present disclosure generally provides a vehicle 10, e.g., a golf car, comprising one or more multi-use accessory retention loop 14 that is/are structured and operable to be conveniently located and accessible to a passenger or user of the vehicle 10 and to easily receive, retain and allow for easy removal of passenger/user personal items or accessories such as golf gloves, towels, carabiners, hooks, golf club brushes, etc. Although the vehicle 10 is exemplarily illustrated in the various figures as a golf car, and will be exemplarily described herein with regard to a golf car, the vehicle 10 can be any vehicle where a passengers/user may have a need or desire to temporarily hang personal items such as golf gloves and towels to allow such items to dry, and remain within the scope of the present disclosure. For example, it is envisioned that the vehicle 10 can be a golf car, a passenger transport or shuttle vehicle, a maintenance or ground care utility vehicle, a turf mower, a cargo vehicle, or any other vehicle.

The vehicle 10 generally includes a chassis or frame 18, a pair of rear wheels 22 and a pair of front wheels 26 operationally connected to the chassis 18, and a passenger compartment 30. The passenger compartment 30 generally includes an instrument panel or dash console 34, a floorboard 38, and a passenger seating structure 42. The instrument panel/dash console 34 can include one or more instrument displays, gauges, vehicle control devices and/or storage compartments. The seating structure 42 comprises a seat bottom 42A, a seat back 42B and a pair of hip restraints 42C. The hip restraints 42C are structured and operable to provide a grab handle for a passenger/user sitting in the seating structure 42 and to provide a barrier from the passenger/user sliding off a side of the seat bottom 42A. The passenger compartment 30 additionally includes a steering wheel 46 for use by the passenger/user to control the directional movement of the vehicle 10, a brake pedal 50 for use by the passenger/user to control slowing and stopping of the vehicle 10, and an accelerator pedal 54 for use by the operator to control the torque delivered by a prime mover 58 (described below) to one or more of the rear and/or front wheels 22 and/or 26. Particularly, the prime mover 58 is operatively connected to a drivetrain 62 that is operatively connected between the prime mover and at least one of the rear and/or front wheels 22 and/or 26.

The vehicle 10 further comprises a vehicle electrical power source 66 (e.g., one or more battery) that is structured and operable to provide electrical power to various electrical components of the vehicle 10 (e.g., a vehicle motor if the prime mover 58 is an electric motor, and other vehicle electrically operated modules and components), and a vehicle main control module 70 that is communicatively (wired or wirelessly) connected to a computer-based prime mover control unit (PMCU) 74. The PMCU 74 is structured and operable to control various operations of the vehicle prime mover 58 such as air/fuel ratio, spark timing and engine speed (e.g., RPM) if the prime mover 58 is an internal combustion engine, and motor speed and torque output if the prime mover 58 is an electric motor). The vehicle main control module 70 is structured and operable to communicate with the PMCU 74 and control various other vehicle modules, devices and operations. The prime mover 58 can be any device that is structured and operable to generate torque (e.g., motive force, e.g., power) utilized to provide motive force for the vehicle 10 via the drivetrain 62. For example, in various embodiments, the prime mover 58 can be an internal combustion engine (ICE), an electric motor, a hybrid combination of an ICE and an electric motor, or any other suitable motive power source and remain within the scope of the present disclosure. Operation of the prime mover 58 is generally controlled by PMCU 74 to generate torque (e.g., motive force, e.g., power) utilized to provide motive force for the vehicle 10 via the drivetrain 62. For example, in various embodiments wherein the prime mover 58 is an internal combustion engine the PMCU 74 can control engine speed and torque output by controlling a fuel/air mixture ratio and/or a spark ignition timing of the engine. Or, for example, in various embodiments wherein the prime mover 58 is an electric motor, the PMCU 74 can control the amount of voltage provided to the motor from the electrical power source 66.

In various embodiments, the vehicle 10 can further comprise a canopy system 80 mounted to the vehicle 10 and disposed over and around the passenger compartment 30. The canopy system 80 is structured and operable to protect passengers of the vehicle 10 from rain, water and sunlight, and to channel or direct water or rain or other liquid away from the passenger(s) and passenger compartment 30. In various embodiments the canopy system 80 comprises at least one rear strut, column or pillar 86 that is mountable to a rear deck and/or the chassis 18 and/or other rearward structure of the vehicle 10, at least one front strut, column or pillar 90 that is mountable to a front cowl and/or the chassis 18 and/or other forward structure of the vehicle 10, and a canopy 82 that is mountable to the front strut(s), column(s) or pillar(s) 90 and the rear canopy front strut(s), column(s) or pillar(s) 86.

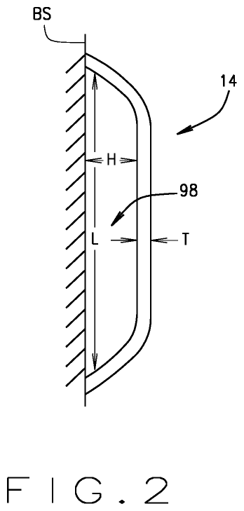

Referring now to FIGS. 1 and 2, as described above, the vehicle 10 includes one or more multi-use accessory retention loop 14 that is/are structured and operable to be conveniently located and accessible to a passenger or user of the vehicle 10 and to easily receive, retain and allow for easy removal of passenger/user personal items or accessories such as golf gloves, towels, carabiners, hooks, golf club brushes, etc. The multi-use accessory loop(s) 14 can be any loop structure disposed on, mounted to, or integrally formed with any suitable base structure of the vehicle 10 (generically illustrated in FIG. 2 as base structure BS). For example, in various embodiments the multi-use accessory loop(s) 14 can be disposed on, mounted to, or integrally formed with a sweater basket and golf bag retention structure 78, the instrument panel 34, an underside of a canopy 82, at least one rear canopy strut 86, at least one front canopy strut 90, the seat back 42B, at least one of the hip restraints 42C, a sand bottle retention cup 94, and/or any other suitable structure of the vehicle 10. The multi-use accessory loop(s) 14 can have any desired shape that form a loop, gap or space 98 between the loop 14 and the base structure BS to which it is disposed on, mounted to, or integrally formed with. For example, in various embodiments, the multi-use accessory loop(s) 14 can have a shape such that the defines loop, gap or space 98 as a square, rectangle, triangle, semi-circle, semi-oval, parallelogram, semi-hexagon, semi-pentagon, semi-octagon, etc. Accordingly, the multi-use accessory loop(s) 14 can have a shape such that the loop, gap or space 98 can have any length L and height H.

Additionally, the multi-use accessory loop(s) 14 can be fabricated of any desirable material and have any desired thickness T that provides sufficient rigidity, stiffness and durability such that passengers/users of the vehicle 10 can insert passenger/user personal items or accessories into and through the loop, gap or space 98 to hang, store or retain the passenger/user personal items or accessories, and subsequently remove the passenger/user personal items or accessories from within the loop, gap or space 98 without bending, breaking or damaging the multi-use accessory loop(s) 14. For example, in various embodiments, can be fabricated of desired metal (e.g., aluminum or steel), any desired plastic or composite such as nylon, acrylic, polycarbonate, polyethylene, polypropylene, polyvinyl, fiberglass, epoxy resin, etc. and have a thickness T of between 1/16 inch to 1 inch (e.g., ⅛ inch to ¼ inch). Furthermore, the multi-use accessory loop(s) 14 can be fabricated using any desirable manufacturing and/or fabrication process or method. For example, in various embodiments, wherein the multi-use accessory loop(s) 14 are disposed on, mounted to the base structure BS, the multi-use accessory loop(s) 14 can be fabricated using an extrusion process, a milling process, an injection molding process, or any other manufacturing and/or fabrication process or method. Similarly, in various embodiments, wherein the multi-use accessory loop(s) 14 are integrally formed with base structure BS, the multi-use accessory loop(s) 14 can be molded along with, or milled into, or otherwise integrally formed with the base structure BS.

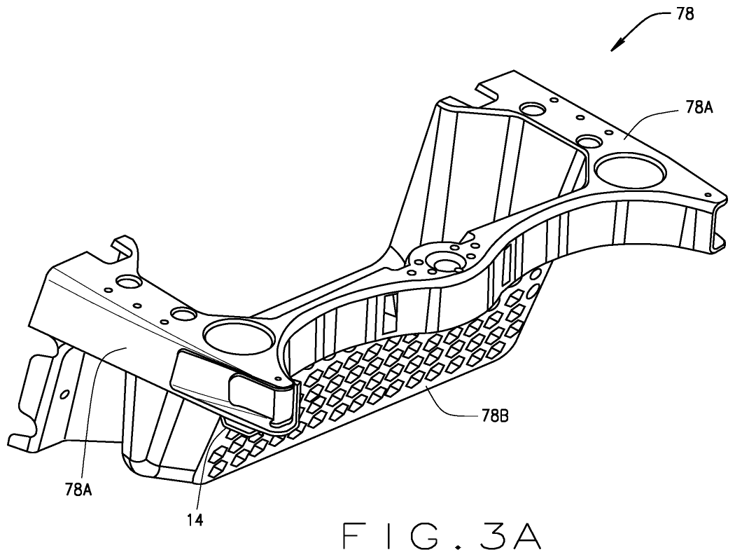

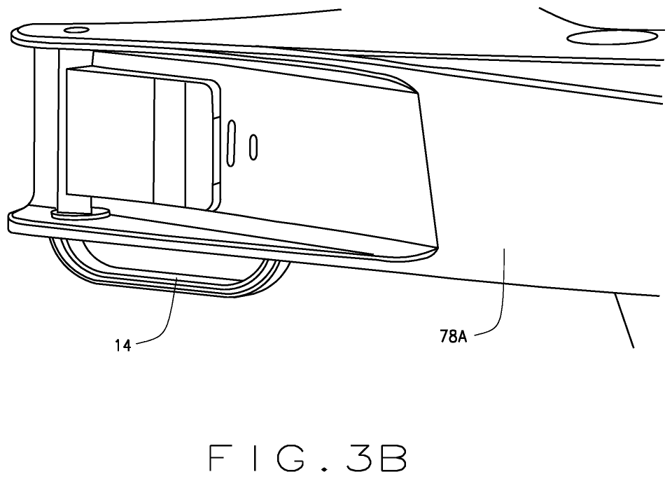

Referring now to FIGS. 1, 2, 3A and 3B, as described above, in various embodiments the multi-use accessory retention loop(s) 14 can be disposed on, mounted to, or integrally formed with the sweater basket and golf bag retention structure 78 of the vehicle 10. In such embodiments, the multi-use accessory retention loop(s) 14 can be disposed on, mounted to, or integrally formed with any part of the sweater basket and golf bag retention structure 78 of the vehicle 10. For example, in various instances, the multi-use accessory retention loop(s) 14 can be disposed on, mounted to, or integrally formed with one or more of a pair of yoke arms 78A of the sweater basket and golf bag retention structure 78. However, it is envisioned that in other instances the multi-use accessory retention loop(s) 14 can be disposed on, mounted to, or integrally formed with any other portion of the sweater basket and golf bag retention structure 78 such as a side or bottom of a sweater basket 78B of the sweater basket and golf bag retention structure 78. Although, a single multi-use accessory retention loop 14 is exemplarily illustrated in FIGS. 3A and 3B as being disposed on a distal or rearward end portion of a bottom surface of one of the yoke arms 78A, it is envisioned that one or more of the multi-use accessory retention loop(s) 14 can be disposed at any location along any surface (e.g., bottom, top, side surfaces) of one or both of the yoke arms 78A.

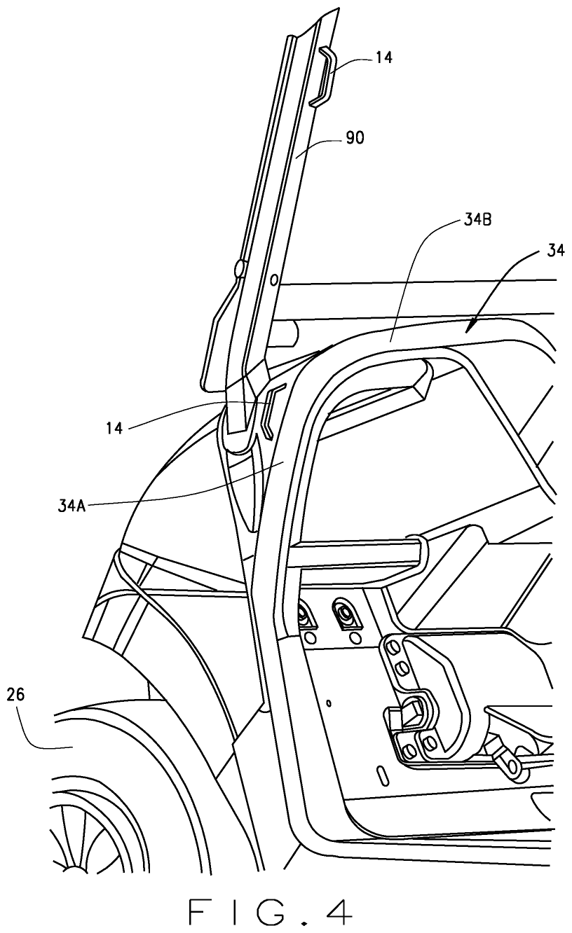

Referring now to FIGS. 1, 2 and 4, as described above, in various embodiments the multi-use accessory retention loop(s) 14 can be disposed on, mounted to, or integrally formed with the dash console/instrument panel 34 of the vehicle 10. In such embodiments, the multi-use accessory retention loop(s) 14 can be disposed on, mounted to, or integrally formed with any portion of the dash console/instrument panel 34. For example, in various instances, the multi-use accessory retention loop(s) 14 can be disposed on, mounted to, or integrally formed with a driver's side sidewall 34A of the dash console/instrument panel 34. Although, a single multi-use accessory retention loop 14 is exemplarily illustrated in FIG. 4 as being disposed on a driver's side sidewall of the dash console/instrument panel 34, it is envisioned that one or more of the multi-use accessory retention loop(s) 14 can be disposed at any location along any surface of the dash console/instrument panel 34 such as a top panel 34B of the dash console/instrument panel 34 and/or a passenger's side sidewall (not shown) of the dash console/instrument panel 34. As also described above, in various embodiments the multi-use accessory retention loop(s) 14 can be disposed on, mounted to, or integrally formed with one or more of the front canopy struts 90. In such embodiments, the multi-use accessory retention loop(s) 14 can be disposed on, mounted to, or integrally formed with any portion of the front canopy strut(s) 90. For example, in various instances, the multi-use accessory retention loop(s) 14 can be disposed on, mounted to, or integrally formed with a rearward face the front canopy strut(s) 86. Although, a single multi-use accessory retention loop 14 is exemplarily illustrated in FIG. 4 as being disposed on the rearward face of the front canopy strut(s) 86, it is envisioned that one or more of the multi-use accessory retention loop(s) 14 can be disposed at any location along any surface of the front canopy strut 90 such as the rearward face and/or a forward face and/or an interior face and/or an exterior face of the one or more front canopy struts 86.

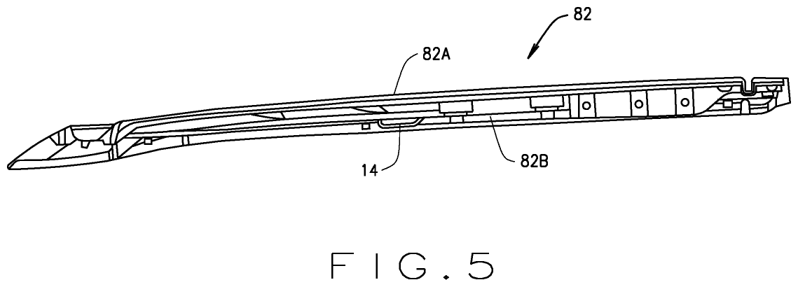

Referring now to FIGS. 1, 2 and 5, as described above, in various embodiments the multi-use accessory retention loop(s) 14 can be disposed on, mounted to, or integrally formed with the canopy 82 of the canopy system 80 of the vehicle 10. In such embodiments, the multi-use accessory retention loop(s) 14 can be disposed on, mounted to, or integrally formed with any portion of the canopy 82. For example, in various instances, the multi-use accessory retention loop(s) 14 can be disposed on, mounted to, or integrally formed with an interior or underside of a top panel 82A of the canopy 82. Although, a single multi-use accessory retention loop 14 is exemplarily illustrated in FIG. 5 as being disposed on the interior or underside of the top panel 82A canopy 82, it is envisioned that one or more of the multi-use accessory retention loop(s) 14 can be disposed at any location along any surface of the canopy 82 such as the interior or underside the top panel 82A and/or an interior portion of one or more opposing sidewalls 82B of the dash canopy 82 and/or an exterior portion of one or more if the opposing sidewalls 82B.

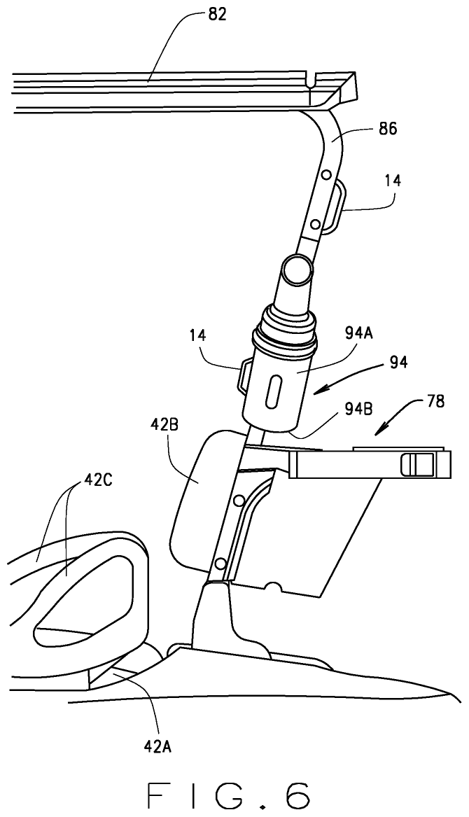

Referring now to FIGS. 1, 2 and 6, as described above, in various embodiments the multi-use accessory retention loop(s) 14 can be disposed on, mounted to, or integrally formed with the sand bottle retention cup of the vehicle 10. In such embodiments, the multi-use accessory retention loop(s) 14 can be disposed on, mounted to, or integrally formed with any portion of the canopy 82. For example, in various instances, the multi-use accessory retention loop(s) 14 can be disposed on, mounted to, or integrally formed with a sidewall 94A of the retention cup 94. Although, a single multi-use accessory retention loop 14 is exemplarily illustrated in FIG. 6 as being disposed on the sidewall 94A of the retention cup 94, it is envisioned that one or more of the multi-use accessory retention loop(s) 14 can be disposed at any location along any surface of the retention cup 94 such as the sidewall 94A and/or a bottom 94B of the retention cup 94. As also described above, in various embodiments the multi-use accessory retention loop(s) 14 can be disposed on, mounted to, or integrally formed with one or more of the rear canopy struts 86. In such embodiments, the multi-use accessory retention loop(s) 14 can be disposed on, mounted to, or integrally formed with any portion of the rear canopy strut(s) 86. For example, in various instances, the multi-use accessory retention loop(s) 14 can be disposed on, mounted to, or integrally formed with a rearward face the rear canopy strut(s) 86. Although, a single multi-use accessory retention loop 14 is exemplarily illustrated in FIG. 6 as being disposed on the rearward face of the rear canopy strut(s) 86, it is envisioned that one or more of the multi-use accessory retention loop(s) 14 can be disposed at any location along any surface of the rear canopy strut(s) 86 such as the rearward face and/or a forward face and/or an interior face and/or an exterior face of the one or more rear canopy struts 86.

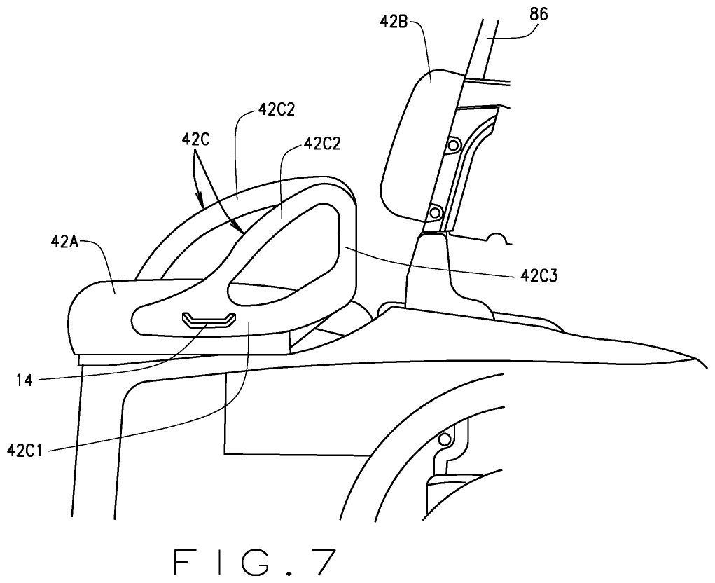

Referring now to FIGS. 1, 2 and 7, as described above, in various embodiments the multi-use accessory retention loop(s) 14 can be disposed on, mounted to, or integrally formed with one or more of the hip restraints 42C of the seating structure 42 of the vehicle 10. In such embodiments, the multi-use accessory retention loop(s) 14 can be disposed on, mounted to, or integrally formed with any portion of one or both of the hip restraints 42C. For example, in various instances, the multi-use accessory retention loop(s) 14 can be disposed on, mounted to, or integrally formed with a lower rail 42C1 of one or both of the hip restraints 42C. Although, a single multi-use accessory retention loop 14 is exemplarily illustrated in FIG. 7 as being disposed on lower rail 42C1 of the driver's side hip restraint 42C, it is envisioned that one or more of the multi-use accessory retention loop(s) 14 can be disposed at any location along any surface one or both of the hip restraints 42C such as the lower rail 42C1 and/or an upper rail 42C2 of one or both hip restraints 42 and/or an rear rail 42C3 of one or both of the hip restraints 42.

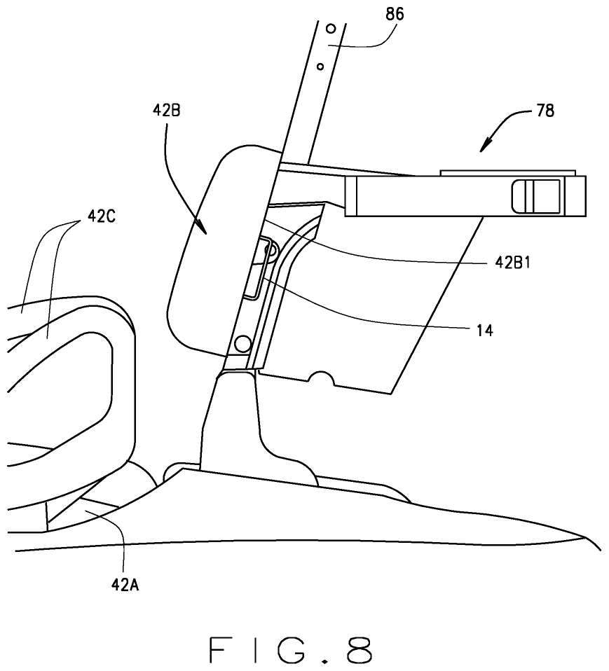

Referring now to FIGS. 1, 2 and 8, as described above, in various embodiments the multi-use accessory retention loop(s) 14 can be disposed on, mounted to, or integrally formed with seat back 42B of the seating structure 42 of the vehicle 10. In such embodiments, the multi-use accessory retention loop(s) 14 can be disposed on, mounted to, or integrally formed with any portion of seat back 42B. For example, in various instances, the multi-use accessory retention loop(s) 14 can be disposed on, mounted to, or integrally formed with a back panel 42B1 of the seat back 42B. Although, a single multi-use accessory retention loop 14 is exemplarily illustrated in FIG. 8 as being centrally located along a driver's side of the back panel 42B1, it is envisioned that one or more of the multi-use accessory retention loop(s) 14 can be disposed at any location along back panel 42B1 such as centrally located on the driver's side of the back panel 42B1 and/or near a top and/or a bottom of the driver's side of the back panel 42B1 and/or centrally located on the passenger's side of the back panel 42B1 and/or near a top and/or a bottom of the passenger's side of the back panel 42B1.

The description herein is merely exemplary in nature and, thus, variations that do not depart from the gist of that which is described are intended to be within the scope of the teachings. Moreover, although the foregoing descriptions and the associated drawings describe example embodiments in the context of certain example combinations of elements and/or functions, it should be appreciated that different combinations of elements and/or functions can be provided by alternative embodiments without departing from the scope of the disclosure. Such variations and alternative combinations of elements and/or functions are not to be regarded as a departure from the spirit and scope of the teachings.

What is claimed is:

1. A vehicle, said vehicle comprising:
a chassis;
a plurality of wheels operatively connected to the chassis;
a passenger compartment supported by the chassis; and
at least one multi-use accessory retention loop disposed on the vehicle and structured and operable to retain a passenger personal item.

2. The vehicle of claim 1 further comprising a sweater basket and golf bag retention structure structured and operable to stow passenger personal items, wherein the at least one multi-use accessory retention loop is disposed on the sweater basket and golf bag retention structure.

3. The vehicle of claim 1 further comprising a canopy system structured and operable to protect passengers within the passenger compartment from rain, water and sunlight, said canopy system comprising:
at least one front strut;
at least one rear strut; and
a canopy mountable to the at least one front strut and the at least one rear strut,
wherein the at least one multi-use accessory retention loop is disposed on the canopy.

4. The vehicle of claim 1 further comprising a canopy system structured and operable to protect passengers within the passenger compartment from rain, water and sunlight, said canopy system comprising:
at least one front strut;
at least one rear strut; and
a canopy mountable to the at least one front strut and the at least one rear strut,
wherein the at least one multi-use accessory retention loop is disposed on the at least one rear strut.

5. The vehicle of claim 1 further comprising a canopy system structured and operable to protect passengers within the passenger compartment from rain, water and sunlight, said canopy system comprising:
at least one front strut;
at least one rear strut; and
a canopy mountable to the at least one front strut and the at least one rear strut,
wherein the at least one multi-use accessory retention loop is disposed on the at least one front strut.

6. The vehicle of claim 1 further comprising a canopy system structured and operable to protect passengers within the passenger compartment from rain, water and sunlight, said canopy system comprising:
at least one front strut;
at least one rear strut; and
a canopy mountable to the at least one front strut and the at least one rear strut,
wherein the at least one multi-use accessory retention loop is disposed on at least one sand bottle retention cup mounted to at least of the at least one rear strut and the at least one front strut.

7. The vehicle of claim 1 wherein the passenger compartment comprises:
a seating structure including a seat bottom, a seat back and a pair of hip restraints; and
an instrument panel,
wherein the at least one multi-use accessory retention loop is disposed on the instrument panel.

8. The vehicle of claim 1 wherein the passenger compartment comprises:
a seating structure including a seat bottom, a seat back and a pair of hip restraints; and
an instrument panel,
wherein the at least one multi-use accessory retention loop is disposed on the seat back.

9. The vehicle of claim 1 wherein the passenger compartment comprises:
a seating structure including a seat bottom, a seat back and a pair of hip restraints; and
an instrument panel,
wherein the at least one multi-use accessory retention loop is disposed on at least one of the pair of hip restraints.

10. A vehicle, said vehicle comprising:
a chassis;
a plurality of wheels operatively connected to the chassis;
a passenger compartment supported by the chassis, the passenger compartment comprising:
a seating structure including a seat bottom, a seat back and a pair of hip restraints; and
an instrument panel;
a canopy system structured and operable to protect passengers within the passenger compartment from rain, water and sunlight, said canopy system comprising:
at least one front strut;
at least one rear strut; and
a canopy mountable to the at least one front strut and the at least one rear strut;
a sweater basket and golf bag retention structure mounted to the at least one rear strut and structured and operable to stow passenger personal items; and
at least one multi-use accessory retention loop disposed on the vehicle and structured and operable to retain a passenger personal item.

11. The vehicle of claim 10, wherein the at least one multi-use accessory retention loop is disposed on the sweater basket and golf bag retention structure.

12. The vehicle of claim 10, wherein the at least one multi-use accessory retention loop is disposed on the instrument panel.

13. The vehicle of claim 10, wherein the at least one multi-use accessory retention loop is disposed on the canopy.

14. The vehicle of claim 10, wherein the at least one multi-use accessory retention loop is disposed on the at least one rear strut.

15. The vehicle of claim 10, wherein the at least one multi-use accessory retention loop is disposed on the at least one front strut.

16. The vehicle of claim 10, wherein the at least one multi-use accessory retention loop is disposed on the seat back.

17. The vehicle of claim 10, wherein the at least one multi-use accessory retention loop is disposed on at least one of the pair of hip restraints.

18. The vehicle of claim 10, wherein the at least one multi-use accessory retention loop is disposed on at least one sand bottle retention cup mounted to at least of the at least one rear strut and the at least one front strut.

19. The vehicle of claim 10, wherein the at least one multi-use accessory retention loop comprises two or more multi-use accessory retention loops and wherein the two or more multiple multi-use accessory retention loops are disposed on two or more of:
the sweater basket and golf bag retention structure;
the instrument panel;
the canopy;
the at least one rear strut;
the at least one front strut;
the seat back;
at least one of the pair of hip restraints; and
at least one sand bottle retention cup mounted to at least of the at least one rear strut and the at least one front strut.

20. A vehicle sweater basket and golf bag retention structure mounted to at least one rear strut of a canopy system of the vehicle and structured and operable to stow passenger personal items, wherein said sweater basket and golf bag retention structure comprises at least one multi-use accessory retention loop structured and operable to retain a passenger personal item.
